(19) United States
(12) Patent Application Publication
(10) Pub. No.: US 2019/0087592 A1
(43) Pub. Date: Mar. 21, 2019

(54) DATA PROTECTION METHOD

(71) Applicant: Tiffany Gray, Sugarland, TX (US)

(72) Inventor: Tiffany Gray, Sugarland, TX (US)

(21) Appl. No.: 15/943,571

(22) Filed: Apr. 2, 2018

Related U.S. Application Data
(60) Provisional application No. 62/561,374, filed on Sep. 21, 2017.

(51) Int. Cl. G06F 21/62; G06F 21/30; G06F 21/79

(52) U.S. Cl. CPC G06F 21/62; G06F 21/46; G06F 21/79; G06F 21/305

(57) ABSTRACT

A data protection method includes a data protection application that stores a security policy when executed on a portable electronic device. The security policy may password protect and prohibit access to chosen data stored on the portable electronic device. The security policy may enable a trackless feature for a duration of time chosen by a user. The trackless function encrypts all data of the immediate usage of the phone. The encrypted data is subsequently deleted after immediate use. The data protection application may further aid in the configuration of the security policy by presenting the user with existing functions of the device that may be protected. The user may be prompted to hide and prohibit access to features and applications on the device. The data protection method is useful for adding passwords to specific applications and features on a device.

### CROSS-REFERENCE TO RELATED APPLICATION(S)

The present application is related to and claims priority to U.S. Provisional Patent Application No. 62/561,374 filed Sep. 21, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of security means of existing art and more specifically relates to mobile device security.

### RELATED ART

Mobile devices are prominent in today's society due to the need for quick and efficient communication. Nearly every adult owns at least one mobile device. As a society we have grown heavily dependent on our mobile devices, more particularly our cellular telephones. Cellular telephones allow their owners to communicate without restriction through internet connectivity provided through cellular towers. Cellular telephones and other mobile devices alike, accumulate data and information pertinent to their owner's well being. Individuals keep banking and other security information on their mobile devices that would be detrimental to the owner if the mobile device was lost or stolen. Further security concerns are developed when mobile devices are shared. Presently, only thin layers of protection are provided for securing the data retained on a mobile device. Further security beyond what is provided by a manufacture of a mobile device may be cost prohibitive or difficult to use. A solution is desired.

U.S. Pat. No. 7,957,532 to YuQun Chen relates to data protection for a mobile device. The described data protection for a mobile device includes a network-based data protection scheme for a mobile device that utilizes encryption techniques and a remote key server that stores encryption keys on behalf of the mobile device. The mobile device stores encrypted data, preferably having no unencrypted counterpart stored therewith. On an as-needed basis, the mobile device requests a decryption key (or an encrypted version of a decryption key) from the key server, where the decryption key can be used by the mobile device to decrypt the encrypted information. The key server transmits the decryption key to the mobile device after authenticating the user of the mobile device.

### SUMMARY OF THE INVENTION

In view of the foregoing disadvantages inherent in the known mobile device security art, the present disclosure provides a novel data protection method. The general purpose of the present disclosure, which will be described subsequently in greater detail, is to provide an efficient and effective data protection method.

A data protection method is disclosed herein. The data protection method includes use of a portable electronic device. The portable electronic device may embody a phone, tablet, laptop or desktop computer. The portable electronic device may include a non-transitory machine readable storage medium. The storage medium may include a data protection application installed. The data protection application may comprise a set of instructions configured to increase the security of the portable electronic device. The data protection application may be programmed to gather information from the user to create and store a security policy. The security policy may envelop (comprise) all existing data on the storage medium of the portable electronic device. The security policy may then prohibit/allow access to existing data on the storage medium through a password prompt. The security policy may be activated for a duration of time set by the user. While the security policy is activated on a portable electronic device, usage of the device is effectively trackless. The trackless operation feature of the security policy may encrypt all data involved phone operation use. The encrypted data is then securely deleted after immediate usage. Another function of the data protection program is compiling and presenting all the existing data for a user to add to the security policy. Presenting existing data allows a user to choose which features and applications will be hidden and guarded by a password prompt.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a data protection method, constructed and operative according to the teachings of the present disclosure.

FIG. 1 is a view of the data protection method during an ‘in-use’ condition, according to an embodiment of the disclosure.

FIG. 2 is another view of the data protection method of FIG. 1, according to an embodiment of the present disclosure.

FIG. 3 is another view of the data protection method of FIG. 1, according to an embodiment of the present disclosure.

FIG. 4 is another view of the data protection method of FIG. 1, according to an embodiment of the present disclosure.

FIG. 5 is a flow diagram illustrating a method for protecting data, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a mobile device security and more particularly to a data protection method as used to improve the protection of data in at least one mobile device.

Generally, security features on mobile devices are easy to circumvent. The existing passcode functionality for a mobile device grants a user complete access to the device once the passcode has been entered. The single layer of protection effectively relinquishes all information stored on the mobile device to whoever has the access code. The owner of a mobile device may be reluctant to share the mobile device with friends or family due to this security risk. The present invention provides additional layers of security to a mobile device. The present invention may allow the owner of a portable electronic device to create a security policy that prohibits access to various areas of the device. The areas may include emails, text messages, call history, stored files and any other form of data on the device.

The present invention effectively adds additional security features to an existing portable electronic device. One of the additional security features is the ability to protect individual applications on the device with an access barrier. The access barrier may be in the form of a numeric string or a biometric input, such as a fingerprint scanner. The present invention may further provide the function of protecting groups of applications behind an access barrier. The owner of the portable electronic device may select what applications and features will be prohibited by the access barrier. The user may select if the protected applications are visible when being protected.

A further security feature of this present invention is the trackless operation of a portable electronic device as directed by the security policy. When trackless operation mode is enabled, no data from the immediate operation of the portable electronic device is stored. Further, all process data for immediate operation of the portable electronic device is encrypted in the memory and preferably deleted immediately after use.

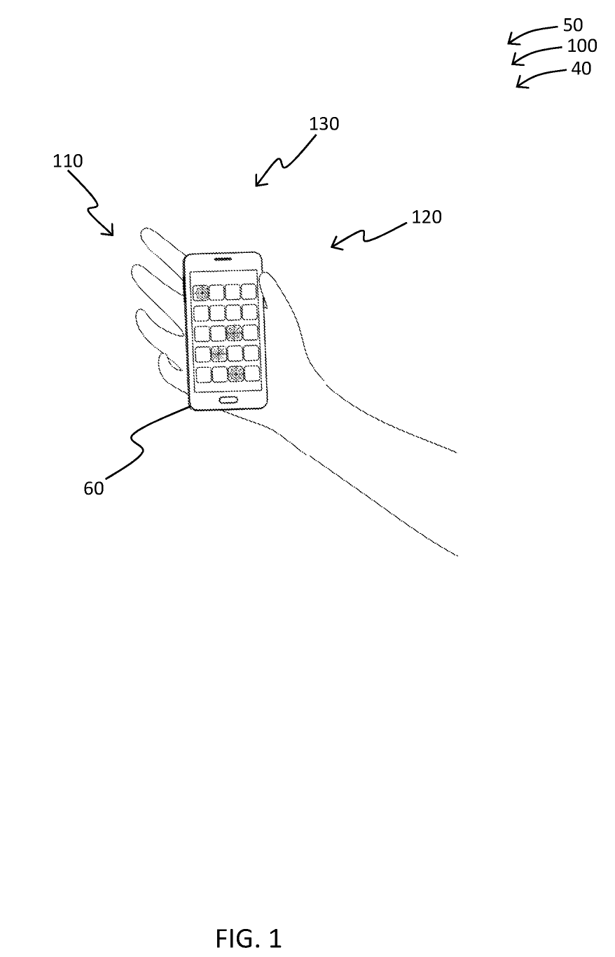

Referring now more specifically to the drawings by numerals of reference, there is shown in FIGS. 1-4, various views of a data protection method 100.

FIG. 1 shows a data protection method 100 during an ‘in-use’ condition 50, according to an embodiment of the present disclosure. Here, the data protection method 100 may be beneficial for use by a user 40 to prohibit access to data on a portable electronic device 60. As illustrated, the data protection method 100 may include a portable electronic device 60. In an embodiment, the portable electronic device 60 may comprise of a phone, a tablet, a laptop or desktop computer. The portable electronic device 60 may be any device that includes a non-transitory machine readable storage medium 110. The non-transitory machine readable storage medium 110 of the portable electronic device 60 includes a data protection application 120 that, when executed on the portable electronic device 60 causes the portable electronic device 60 to perform the steps of: storing a security policy 130, the security policy 130 comprising instructions that prohibits access to at least one predefined location in the non-transitory machine readable storage medium 110 after a threshold of password access attempts; and, activating the security policy 130; the security policy 130 is active for a duration of time being enabled at a start time and disabled at an end time. In response to activating the security policy 130, a subsequent step is encrypting all data used in the immediate operation of the portable electronic device 60, the data prohibited from being retained in the non-transitory machine readable storage medium 110 outside of immediate operation. A further step pertaining to initialization of the security policy 130 is providing the user 40 of the portable electronic device 60 preselected non-transitory machine readable storage medium 110 addresses to add to the security policy 130.

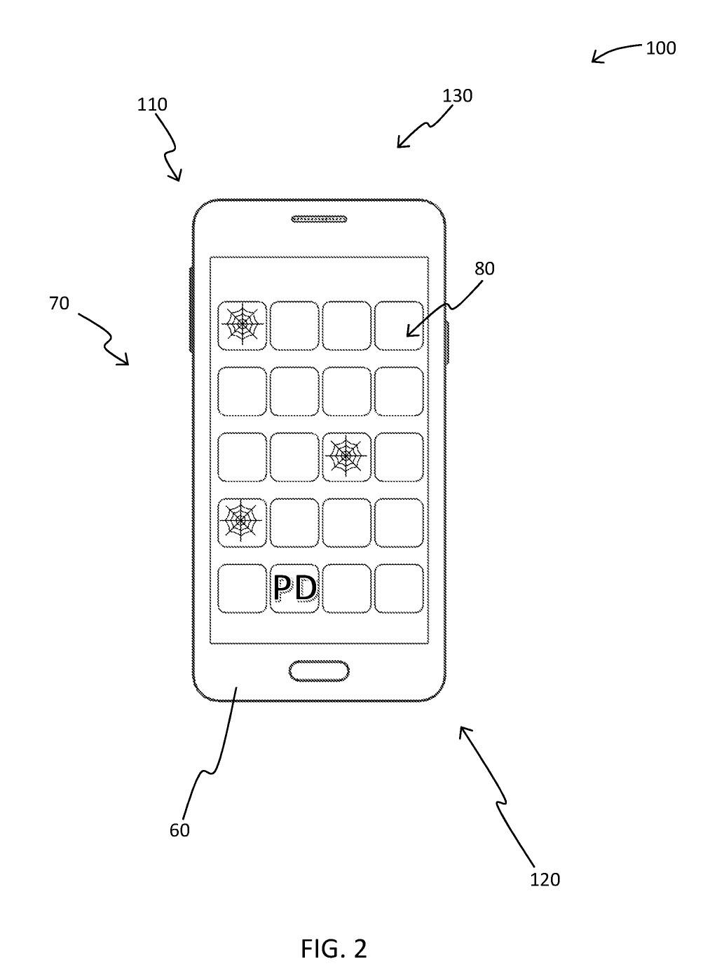

FIG. 2 shows the data protection method 100 of FIG. 1, according to an embodiment of the present disclosure. As above, the data protection method 100 may include a portable electronic device 60 having a non-transitory machine readable storage medium 110 comprising a data protection application 120. The data protection application 120 may be configured to compile and store a security policy 130 configured to aid in the protection of data on the non-transitory machine readable storage medium 110 of the portable electronic device 60. The non-transitory machine readable storage medium 110 may include an operating system 70. The operating system 70 may be pre-loaded and configured to host a plurality of applications 80. The security policy 130 may be adapted to function with the operating system 70 and all applications 80 therein.

The security policy 130 may be configured to receive instructions remotely. This function may be useful if the portable electronic device 60 is not under direct supervision of the user 40 (FIG. 1). The data protection application 120 may be configured to communicate through internet capability. The internet capability may allow the data protection application 120 to send and receive instructions according to the security policy 130. The security policy 130 may further be configured to receive instructions through Short Message Service (SMS). The security policy 130 may further initiate communication with a Virtual Private Network (VPN). The VPN connection may be configured to provide a secure connection medium for the security policy 130 of the data protection application 120 to function through the internet.

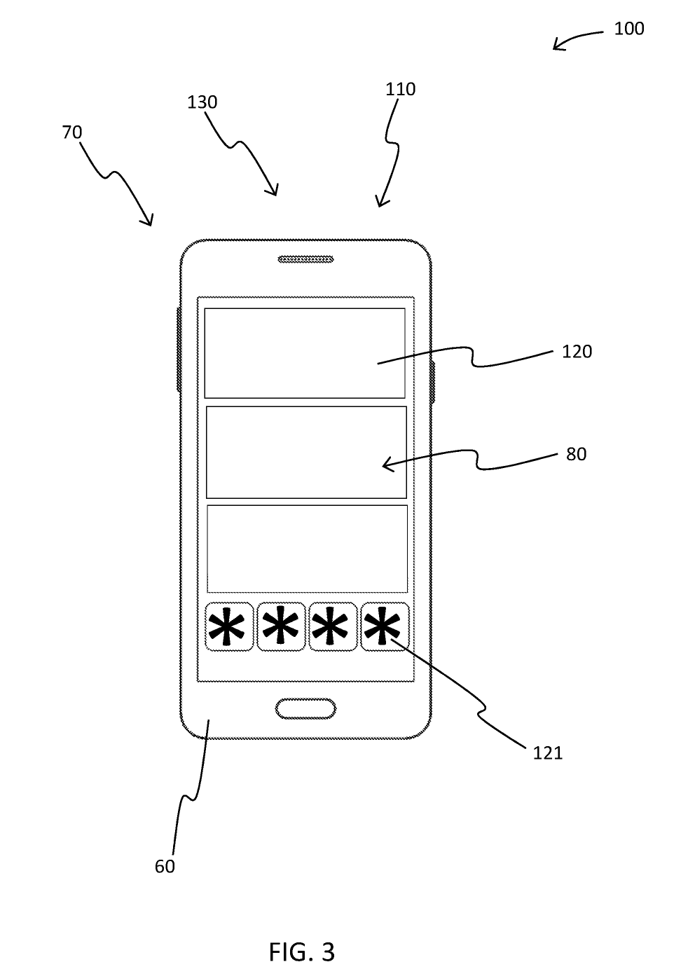

Referring now to FIG. 3, another view of the data protection method 100 of FIG. 1, according to an embodiment of the present disclosure. The data protection method 100 may include a portable electronic device 60 having a non-transitory machine readable storage medium 110 of the portable electronic device 60 comprising a data protection application 120. The data protection application 120 may comprise the step of storing a security policy 130; the security policy 130 comprising instructions that prohibits access to at least one predefined location in the non-transitory machine readable storage medium 110 after a threshold of password 121 access attempts. The predefined location in the non-transitory machine readable storage medium 110 may be where applications 80 and the data of the applications 80 are stored. The security policy 130 may prohibit access to the predefined location in the non-transitory machine readable storage medium 110 a user 40 (FIG. 1) thereby prohibiting access to one or more applications 80. The portable electronic device 60 may include an integrated biometric sensor. The data protection application 120 may be in communication with the biometric sensor to retrieve one or more forms of data. In one embodiment, the biometric sensor may comprise a fingerprint scanner. The password 121 of the security policy 130 may be biometric input through a fingerprint scan. In another embodiment the password 121 of the security policy 130 may be a sequence of numbers inputted through the operating system 70.

The data protection application 120 may further comprise the step of activating the security policy 130. The security policy 130 may be active for a duration of time being enabled at a start time and disabled at an end time. During the start and the end of this security policy 130 being enabled, the security policy 130 may be configured with a predetermined communication being digitally sent to a predefined destination. The digital communication may be through utilization of the internet capability. The digital communication may further utilize cellular towers for communication through Short Message Service (SMS). All other conceived means of digital communication are further considered.

In response to activating the security policy 130, the data protection application 120 may encrypt data used in the immediate operation of the portable electronic device 60. The encrypting mechanism of the security policy 130 may adhere to the Advanced Encryption Standard (AES). The security policy 130 may prohibit the data from being retained in the non-transitory machine readable storage medium 110 outside of immediate operation. Prohibiting data from being retained in the non-transitory machine readable storage medium 110 effectively leaves no residual data from the immediate operation of the portable electronic device 60 when the security policy 130 is enabled.

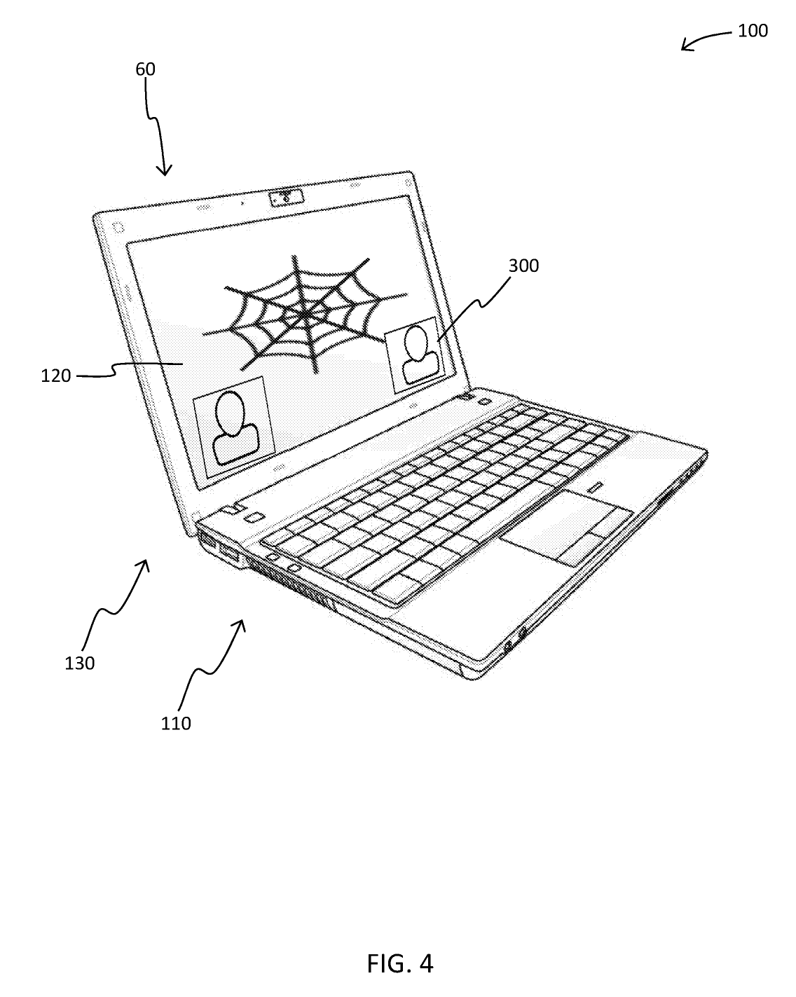

FIG. 4 is another view of the data protection method 100 of FIG. 1, according to an embodiment of the present disclosure. As illustrated, the data protection method 100 may include a portable electronic device 60. In an embodiment the portable electronic device 60 may comprise a phone, a tablet, a laptop or desktop computer or other such suitable device. The portable electronic device 60 may be any device that includes a non-transitory machine readable storage medium 110. The non-transitory machine readable storage medium 110 of the portable electronic device 60 includes a data protection application 120. The data protection application 120 may include a set of instructions where a security policy 130 is created and stored. The security policy 130 comprises instructions that prohibits access to at least one predefined location in the non-transitory machine readable storage medium 110 after a threshold of password access attempts. The security policy 130 may be configured to contain a plurality profiles 300. Each of said profiles 300 may be configured to restrict access to at least one predefined location in the non-transitory machine readable storage medium 110.

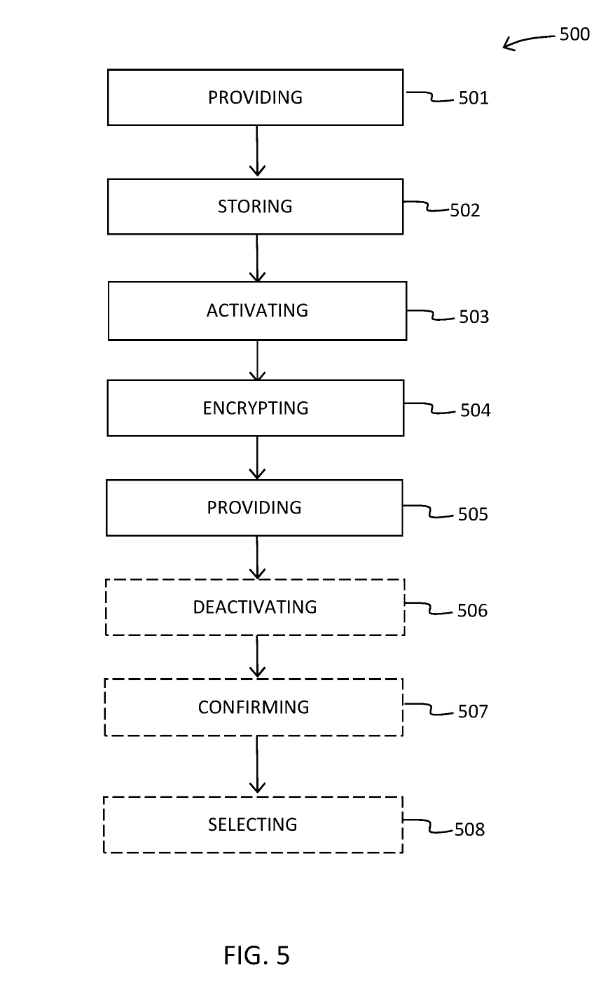

Referring now to FIG. 5 showing a flow diagram illustrating a method 500 for using a data protection method 100, according to an embodiment of the present disclosure. In particular, the method for protecting data 500 may include one or more components or features of the data protection method 100 as described above. As illustrated, the method for protecting data 500 may include the steps of: step one 501, providing a data protection method for a mobile device, the data protection method comprising a portable electronic device, and a non-transitory machine readable storage medium of the portable electronic device comprising a data protection application that, when executed on the portable electronic device causes the portable electronic device to perform the steps of: step two 502, storing a security policy, the security policy comprising instructions that prohibits access to at least one predefined location in the non-transitory machine readable storage medium after a threshold of password access attempts; step three 503, activating the security policy, the security policy is active for a duration of time being enabled at a start time and disabled at an end time; step four 504, in response to activating the security policy, encrypting data used in the immediate operation of the portable electronic device, the data prohibited from being retained in the non-transitory machine readable storage medium outside of immediate operation; step four 504, providing the user of the portable electronic device preselected non-transitory machine readable storage medium addresses to add to the security policy. Further optional steps may include: step five 505, deactivating the security policy in response to a signal sent received by the operating system; step six 506, confirming, prior to encrypting a predefined location in the non-transitory machine readable storage medium after a threshold of password access attempts; and step seven 507, selecting addresses of the non-transitory machine readable storage medium for adaption to the security policy.

It should be noted that step 505, 506, and 507 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for protecting data, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A data protection method for a mobile device, the data protection method comprising:
a portable electronic device;
a non-transitory machine readable storage medium of the portable electronic device comprising a data protection application that, when executed on the portable electronic device causes the portable electronic device to perform the steps of:
storing a security policy, the security policy comprising instructions that prohibits access to at least one predefined location in the non-transitory machine readable storage medium after a threshold of password access attempts;
activating the security policy, the security policy is active for a duration of time being enabled at a start time and disabled at an end time;
in response to activating the security policy, encrypting data used in the immediate operation of the portable electronic device, said data prohibited from being retained in the non-transitory machine readable storage medium outside of immediate operation; and
providing the user of the portable electronic device preselected non-transitory machine readable storage medium addresses to add to the security policy.

2. The data protection method of claim 1, wherein the portable electronic device includes an integrated biometric sensor.

3. The data protection method of claim 1, wherein the data protection application is configured to communicate through internet capability.

4. The data protection method of claim 1, wherein the non-transitory machine readable storage medium includes an operating system.

5. The data protection method of claim 4, wherein the password of the security policy is a sequence of numbers inputted through the operating system.

6. The data protection method of claim 2, wherein the password of the security policy is biometric input through a fingerprint scan.

7. The data protection method of claim 4, wherein the security policy is adapted to function with the operating system and all applications therein.

8. The data protection method of claim 1, wherein by activating the security policy, a predetermined communication is digitally sent to a predefined destination.

9. The data protection method of claim 1, wherein the security policy is configured to receive instructions remotely.

10. The data protection method of claim 1, wherein the security policy is configured to contain a plurality profiles, each of said profiles restricting access to the at least one predefined location in the non-transitory machine readable storage medium.

11. The data protection method of claim 1, wherein the encryption mechanism of the security policy adheres to the Advanced Encryption Standard (AES).

12. The data protection method of claim 1, wherein the security policy initiates communication with a Virtual Private Network (VPN).

13. The data protection method of claim 1, wherein the security policy is configured to receive instructions through Short Message Service (SMS).

14. The data protection method of claim 1, further comprising the step of deactivating the security policy in response to a signal sent received by the operating system.

15. The data protection method of claim 1, further comprising the step of confirming, prior to encrypting a predefined location in the non-transitory machine readable storage medium after a threshold of password access attempts.

16. The data protection method of claim 1, further comprising the step of selecting addresses of the non-transitory machine readable storage medium for adaption to the security policy.

17. A data protection method, the data protection method comprising:
providing a portable electronic device having;
a non-transitory machine readable storage medium of the portable electronic device comprising a data protection application that, when executed on the portable electronic device causes the portable electronic device to perform the steps of:
storing a security policy, the security policy comprising instructions that prohibits access to at least one predefined location in the non-transitory machine readable storage medium after a threshold of password access attempts;
activating the security policy, the security policy is active for a duration of time being enabled at a start time and disabled at an end time;
in response to activating the security policy, encrypting data used in the immediate operation of the portable electronic device, said data prohibited from being retained in the non-transitory machine readable storage medium outside of immediate operation; and
providing the user of the portable electronic device preselected non-transitory machine readable storage medium addresses to add to the security policy;
wherein the portable electronic device includes an integrated biometric sensor;
wherein the data protection application is configured to communicate through internet capability;
wherein the non-transitory machine readable storage medium includes an operating system;
wherein the password of the security policy is a sequence of numbers inputted through the operating system;
wherein the password of the security policy is biometric input through a fingerprint scan;
wherein the security policy is adapted to function with the operating system and all applications therein;
wherein by activating the security policy, a predetermined communication is digitally sent to a predefined destination;
wherein the security policy is configured to receive instructions remotely;
the security policy is configured to contain a plurality profiles, each of said profiles restricting access to the at least one predefined location in the non-transitory machine readable storage medium;
wherein the encryption mechanism of the security policy adheres to the Advanced Encryption Standard (AES);
wherein the security policy initiates communication with a Virtual Private Network (VPN);
wherein the security policy is configured to receive instructions through Short Message Service (SMS);
further comprising the step of deactivating the security policy in response to a signal sent received by the operating system;
further comprising the step of confirming, prior to encrypting a predefined location in the non-transitory machine readable storage medium after a threshold of password access attempts; and
further comprising the step of selecting addresses of the non-transitory machine readable storage medium for adaption to the security policy.
